(19) United States
(12) Patent Application Publication
(10) Pub. No.: US 2025/0192558 A1
(43) Pub. Date: Jun. 12, 2025

(54) SYSTEM FOR STABILIZING ELECTRICITY GRIDS, HAVING CAVERNS FOR GAS STORAGE

(71) Applicant: Stablegrid Engineers GmbH, Thandorf (DE)

(72) Inventor: Oliver FELLER, Hamburg (DE)

(73) Assignee: Stablegrid Engineers GmbH, Thandorf (DE)

(21) Appl. No.: 18/840,149

(22) PCT Filed: Feb. 21, 2023
(86) PCT No.: PCT/EP2023/054286

§ 371 Date: Aug. 21, 2024

(30) Foreign Application Priority Data
Feb. 21, 2022 (DE) 10 2022 104 030.5

(51) Int. Cl. H02J 3/28; H02J 3/38; H02J 15/00

(52) U.S. Cl. CPC H02J 3/28; H02J 3/381; H02J 15/008; H02J 2300/10; H02J 2300/30

(57) ABSTRACT

A system for stabilizing an electricity grid using an energy store is provided. The energy store comprises a gas generator fed by the electricity grid to generate fuel and a cavern comprising a supply line. To store energy, generated fuel is introduced into the cavern via the supply line and, to withdraw energy, is removed from the cavern. The supply line is dual-directional, comprising a filling line and a removal line. It is thus possible to feed fuel into the cavern and to provide negative operating reserve relative to the electricity grid. It is also possible to simultaneously remove fuel from the cavern using the removal line for one of the use units, to generate methane using a methanation plant or for return flow. The system does not involve inconvenient switching processes in the lines thus allowing the operating reserve to be provided rapidly.

### CROSS-REFERENCE TO RELATED APPLICATIONS

This application is a U.S. national stage application under 35 USC 371 of International Patent Application No. PCT/EP2023/054286, filed Feb. 21, 2023, which claims the priority of DE Application No. 102022104030.5, filed on Feb. 21, 2022. The entire contents of each priority application is incorporated herein by reference.

### FIELD OF THE DISCLOSURE

The disclosure relates to a system for stabilization of electricity grids. The system may have a gas storage means in the form of a cavern for gas storage. A gas generator fed from the electricity grid generates gas, especially hydrogen, which can be introduced into the cavern as gas for storage of energy, in order to be able to be withdrawn again as required for release of energy.

### BACKGROUND OF THE DISCLOSURE

In the course of the energy transition to renewable energies, there will be an increase in volatile and decentralized power generation, as typical of power plants operated with renewable energy sources, such as wind turbines or photovoltaic systems. In addition to the ever-present fluctuations on the load side, there will thus also be increasingly more dynamic fluctuations on the generation side. There will also be temporary surpluses in generation, which will subsequently require feed-in management measures, for example the downregulation of power plants. This frequently affects wind turbines since, unlike conventional power plants, they have a high power gradient and hence can be downregulated quickly. This should be viewed critically not just from the point of view of the stability of the power grid, but also with regard to the loss of renewable energy associated with the downregulation of wind turbines. It is unsatisfactory that it is thus the most desirable energy source which is not fully exploited but restricted, and hence the potential available for generation of renewable energy is wasted by the forced shutdown of the wind turbine.

There is therefore a need for storage means for electricity grids in order to be able to better match the fluctuating supply of electrical energy from renewable energies to demand and to need a minimum level of downregulation. As well as battery storage means, which can generally store only small amounts of energy, and pumped storage power plants, which take up a lot of space and the construction of which constitutes a considerable encroachment into the landscape with correspondingly major problems with regard to protection of nature, gas storage means are also important. In the event of surplus electrical power, it is thus possible to generate gas, for example hydrogen gas via electrolysis, and store it in the gas storage means. In this way, a reserve is created, which can be called up if required, in the event of underproduction of electrical power or in the event of high power demand.

Such gas storage means are not necessarily tied to one type of gas. Suitable gases are in particular hydrogen, as already mentioned, and natural gas (generated by methanation) from surplus electrical power. In the case of hydrogen, for example, by means of an electrolyzer, hydrogen is generated from surplus electrical power, and the hydrogen is stored in a cavern. Caverns are large underground cavities that are present in suitable geological strata and are gastight. They may be of natural origin or else have been created artificially, as described, for example, in EP 2 855 306 A1. The gas (in particular hydrogen) is stored in such a cavern via a connection pipe under a high pressure of typically 40 to 200 bar, stored therein over an indeterminate period and withdrawn again by means of the connection pipe as required. The concept enables the storage of large gas volumes and hence correspondingly large amounts of energy. The concept has been found to be useful, especially in the operation of gas grids with comparatively long storage and release cycles. However, this is insufficient for support of the electricity grid fed with volatile renewable energies and the associated high demands on dynamic response in relation to rapid provision of control energy and control power.

### BRIEF SUMMARY OF THE DISCLOSURE

It is an object to provide a system for stabilization of electricity grids which is improved in relation to dynamic response, and which especially avoids or reduces downregulation or shutdown of power plants operated with renewable energies, such as wind parks and wind turbines.

In a system for stabilization of an electricity grid using an energy storage means, wherein the energy storage means comprises a gas generator for a gaseous fuel, especially hydrogen, which is fed from the electricity grid, and a cavern having a connection pipe that leads into the cavern, wherein energy is stored by introducing the gaseous fuel generated by the gas generator into the cavern via the connection pipe and is withdrawn from the cavern for extraction of energy, it is envisaged that the connection pipe is configured as a dual-directional conduit leading into the cavern, which respectively comprises a filling conduit and a separate withdrawal conduit.

The system may be based on the concept that separate conduits for filling and for withdrawal enable both parallel and continuous storage and removal from storage without any need to undertake laborious changeover operations in the conduits and in particular with reversibility of the flow direction in the conduits. What is meant by “parallel” in the present context is that storage overlaps in time with removal from storage. It is thus possible to switch more quickly between the storage of gas (the gaseous fuel) into the cavern and withdrawal from the cavern. The system for stabilization thus may also meet high demands on dynamic response in particular for electricity grids with a high proportion of volatile generation from renewable energies.

The system may enable simultaneous storage and removal-from-storage operations, which was not possible using known techniques. The system may also enable withdrawal at any time during filling. It is thus also possible in the case of withdrawal of gas for there still to be continuous unbuffered filling (without intermediate storage).

Because of the simultaneous filling and withdrawal, it is possible to react in a highly dynamic manner to different demands to take up and/or release energy. The system may be suitable not only as a dynamic energy storage means but also for provision of rapid control power, both by uptake from the electricity grid and by release into the electricity grid (negative and positive control power). The system may thus be suitable for provision of primary control power and, because of its high storage volume of gas as a result of the cavern, also for prolonged provision of secondary control power or of prolonged minute control power. Since caverns can be created efficiently in suitable geological formations or may already be available in any case as a result of prior exploitation of natural gas fields, the system may enable all these benefits with distinctly lower complexity than in the case of conventional known storage techniques, such as by means of buffer batteries or by means of pumped storage power plants.

Appropriately, the dual-directional conduit with its filling conduit is designed for continuous feeding, irrespective of withdrawal, and/or for continuous withdrawal, irrespective of feeding. This independence offers a number of advantages: firstly, sustained drawing of electrical power from the electricity grid is enabled, in order thus to avoid down-regulation of wind turbines even in the event of a surplus power in the grid. Secondly, by virtue of the possibility of continuous filling, it is possible to prevent the storage medium from being emptied. Thirdly, gas can be withdrawn constantly. The cavern is thus available as a large storage means for reserve energy, from which electrical power can be provided and released as required at any time.

Some of the terms used are first elucidated hereinafter:

The electricity grids may especially be transmission grids and distribution grids, as typically operated by one or more network operators in any country. The term does not include networks within buildings.

The gas generator is an apparatus that generates a gaseous fuel by means of electricity. Fuel should be understood in the manner customary in the art to mean a chemical substance, the stored energy of which can be converted to utilizable energy by combustion. For instance, this term encompasses chemical fuels in particular, such as methane, and also electrochemical fuels, such as hydrogen for power generation in fuel cells.

Caverns are underground cavities. They are gastight and may be of natural origin or else may have been created artificially. There are typically certain suitable geological strata in which there are caverns.

Gas withdrawn from the cavern means a gas (gaseous fuel) that has been generated by means of the gas generator and stored in the cavern.

The terms “primary control power”, “secondary control power” and “minute reserve power” are technical terms used by network operators, especially transmission grids. They are defined for those skilled in the art in the rulebook applicable to the respective transmission grids. This may vary from country to country or from control zone to control zone, and so there is no point in specifying the respective criteria, which will be clearly apparent to the person skilled in the art from the corresponding relevant rulebook.

It is advantageously the case that multiple different use units for the gas withdrawn from the cavern may be connected to the withdrawal conduit. In this way, the gas withdrawn from the cavern can optionally also be used in other ways. Apart from a device for reconversion of the gas to power, especially a fuel cell or a combined heat and power plant (CHP plant), the use units may especially be a methanation plant designed to synthesize methane by means of the gaseous fuel (especially hydrogen gas) withdrawn from the cavern and/or in order to feed a transfer point to a gas grid at which the gas withdrawn is fed directly into the gas grid. The gas grid may especially be a natural gas grid. However, there is no intention to exclude the possibility that the grid is for a different gas, especially hydrogen gas.

In order to be able to choose between the different use units, at least one switchable gas manifold may be appropriately connected to the withdrawal conduit, with flow of the gas withdrawn (the gaseous fuel) to one of the different use units depending on the switching state of the gas manifold. It is advantageous here when the gas manifold is also designed for switching of substreams. In this way, it is possible to use a portion of the gas withdrawn for reconversion to power, for example, while another portion of the gas is fed to another of the use units 3, for example the methanation plant. The gas manifold is preferably designed such that it is switchable even in the case of continuous withdrawal. Switchover is thus possible without stopping withdrawal from the cavern.

In a particularly advantageous aspect, a controller for control power may be provided, which has an inlet for a signal for control power, especially negative control power, and which is designed to actuate the gas generator such that a power corresponding to the control power, especially negative control power, is drawn from the electricity grid for production of gas, which is introduced into the cavern. In this way, the system of the invention with its cavern can take part in the provision of control power. The network operator (or another superior authority in the network) will transmit a signal for a requirement for control power. This is frequently a requirement for negative control power; in other words, in the case of excessive production of power, especially by wind turbines, excess power may be withdrawn from the grid. For this purpose, the network operator issues a control signal for negative control power. If this is sent to the controller of the system, in accordance with the control power required, it takes correspondingly more power from the grid, generates gas therefrom and stores it in the cavern. It is thus possible, especially in the case of an electrolyzer as gas generator, to react rapidly within seconds to a surplus of power in the grid. Moreover, because of the large volume of the cavern, it is possible to provide the control power for a comparatively long period, typically for 60 min, and possibly even longer, for several hours.

It is advantageously further the case that the controller for control power also acts on a reconversion-to-power device in order to feed additional power as positive control power into the electricity grid. This is basically a reversal of the above-described operation. An additional power demand arises in the grid, and the grid operator issues a target signal for the feeding of additional power (positive control power). The controller acts accordingly on the reconversion-to-power device, for which gas is withdrawn from the cavern (irrespective of whether further gas is being stored at the same time). The reconversion-to-power device additionally generates electrical power from the gas, for example by means of a fuel cell or a combined heat and power plant (CHP plant), and feeds it into the grid (or releases it to a consumer). This too can firstly be effected in a highly dynamic manner and secondly over a prolonged period because of the high storage volume of the cavern. The CHP plant may, for example, be a hydrogen-operated gas turbine that drives an electricity generator.

Appropriately, a switchable bypass conduit is provided, which is connected to the filling conduit between gas generator and cavern and connects these to the withdrawal conduit. This can be used to direct gas generated by the gas generator as required directly to the use unit (or one of the use units) without prior introduction of the gas into the cavern. In this way, it may be possible to react quickly to changes in the gas demand from one of the use units. It is thus possible to achieve a further increase in the dynamic response of the plant and to increase efficiency.

The cavern basically constitutes a large buffer for the storage of electricity. It may nevertheless be appropriate optionally to additionally provide a buffer accumulator. This is fed by the electricity grid connected to the gas generator and is especially also designed for rapid power release and/or power uptake. It is thus possible, similarly to the bypass conduit in relation to supply with gas, to provide electrical energy particularly rapidly if required, and hence to achieve an increase in the dynamic response in relation to the feeding of electrical energy. It is additionally possible with the buffer accumulator to achieve stabilization and smoothing with regard to the electrical supply of the gas generator, especially the electrolyzer.

Advantageously, the filling conduit and the withdrawal conduit are run into the cavern spaced apart from one another. They appropriately have a separation of at least 5 meters, where this measure of distance may depend on the dimensions (especially diameter) of the filling conduit and withdrawal conduit. The filling conduit and withdrawal conduit are preferably in an adjacent arrangement; this means that the separation based on diameter is between three times and thirty times the diameter, especially at least ten times the diameter and further preferably not more than twenty times the diameter. It may be advantageous to use an average diameter for the purpose; the average diameter means the averaged diameter of the filling conduit or the withdrawal conduit. The manner of averaging should be chosen by the person skilled in the art; it may in particular be an arithmetic mean, a geometric mean or some other type of mean. The (average) diameter may be replaced by a measure of the (average) width of the respective conduit; this is particularly suitable, for example, in the case of a filling conduit and/or withdrawal conduit having a noncircular cross section. Such a separation is intended to have the effect that no harmful flow effects on the withdrawal of gas arise from the incoming gas, and vice versa. What is thus achieved is better decoupling of the filling conduit from the withdrawal conduit and hence minimization of the risk that the filling conduit and withdrawal conduit will affect one another. Especially also in the case of an adjacent arrangement, it is appropriate to provide separate drill shafts for the filling conduit and the withdrawal conduit.

It may alternatively be the case that the dual-directional conduit with its filling conduit and separate withdrawal conduit are disposed in a common drill shaft. In that case, the two conduits for filling and withdrawal are no longer spaced apart from one another, but the functionality of withdrawal independently of storage, and storage independently of withdrawal, is nevertheless assured. This space-saving design is suitable in particular for caverns that are comparatively narrow in their upper region. The combining of the dual-directional conduit in one drill shaft also simplifies production and hence reduces manufacturing complexity.

It may appropriately be the case that the filling conduit and the withdrawal conduit reach into the cavern to different depths by their respective openings, where the filling conduit preferably reaches deeper. In this way, it is possible to use the third dimension, namely the depth of the cavern, in order to achieve improved decoupling between filling conduit and withdrawal conduit. If the withdrawal conduit is disposed with its opening higher in the cavern, this facilitates the withdrawal of gas in the case of a low fill level.

The cavern is appropriately formed in a salt dome. These are particularly suitable for gastight storage because of their geological properties. The cavern here should be distinguished here for the person skilled in the art from what is called a porous storage medium. The cavern is pressure-resistant, and is appropriately designed for an operating pressure of at least 40 bar, preferably up to 200 bar. It has been found that particularly favorable operation of the cavern is enabled in this pressure range, especially with regard to economic operation methodology and geomechanical stability.

In a further aspect, the system may also extend to the cavern for storage of gaseous fuel, where the connection pipe is designed as a dual-directional conduit leading into the cavern, which respectively comprises a filling conduit and a separate withdrawal conduit, preferably adjacent to one another. For the rest, by way of further elucidation of the cavern with its dual-directional conduit, its further configuration and the mode of operation, for avoidance of repetition, reference is made to the description above.

The system is elucidated by way of example hereinafter by advantageous embodiments with reference to the appended drawing. The figures show:

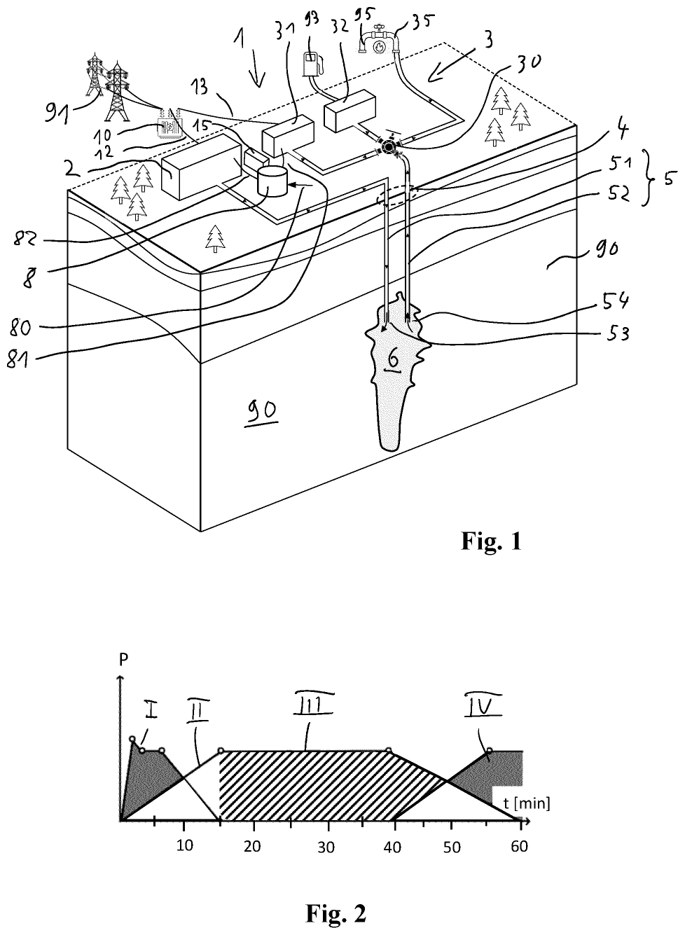

FIG. 1 shows a schematic view of a first embodiment;

FIG. 2 shows a diagram for provision of control power;

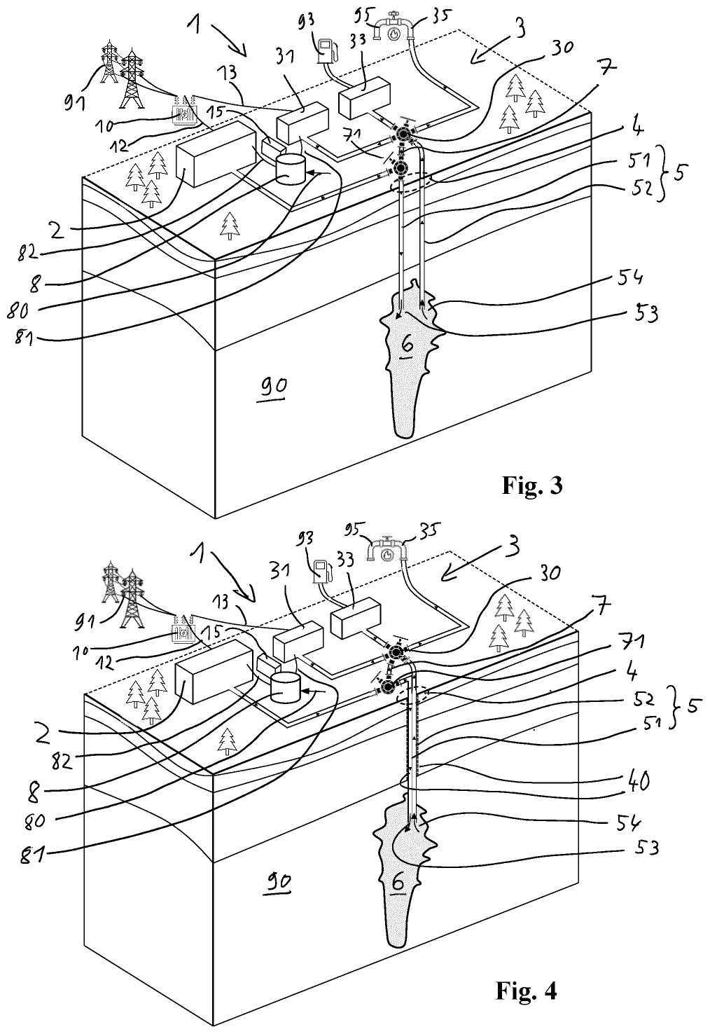

FIG. 3 shows a schematic view of a second embodiment; and

FIG. 4 shows a schematic view of a third embodiment.

### DETAILED DESCRIPTION OF THE DISCLOSURE

FIG. 1 shows the system, using the example of a first embodiment. The system for stabilization of an electricity grid, labelled in its entirety by reference numeral 1, comprises, as main components, a gas generator 2 and use units 3 that are connected to an underground cavern 6 via a pipe connection 4. The cavern 6 is disposed in a subterranean salt dome 90. The system is elucidated using the example of hydrogen as the gas which is generated by the gas generator 2 as gaseous fuel and is stored in the cavern 6; it will be apparent that it is also possible to use other gaseous fuels (for example methane).

The system for stabilization 1 is connected via a plant transformer 10 to an electricity grid 91; in the working example shown, this is a transmission grid of a network operator. The gas generator 2 is connected via a connecting conduit 12 to the plant transformer 10 and is supplied with electrical power thereby. The gas generator 2 is designed to generate hydrogen gas using electrical power. This can be accomplished in a manner known per se; the gas generator 2 is preferably designed as an electrolyzer. However, there are also other possible electrically operated methods of generating hydrogen.

Also connected to the plant transformer 10 via a further connecting conduit 13 is a combined heat and power plant (CHP plant) or a fuel cell 31, which is one of the use units 3. By way of this connecting conduit 13, it is possible to feed electrical power into the transmission grid 91 from the combined heat and power plant, for example from an electricity generator driven by a hydrogen gas turbine, or fuel cell 31, by way of reconversion of hydrogen gas to power.

The gas generator 2 and the use units 3 with the fuel cell 31 are connected to the cavern 6 via a pipe connection 4. The pipe connection 4 is designed here as a dual-directional conduit 5 comprising a filling conduit 51 and a withdrawal conduit 52. The filling conduit 51 is connected to the gas generator 2 and ends in the cavern with its opening 53. It feeds hydrogen gas generated by the gas generator 2 into the cavern 6. The withdrawal conduit 52 is designed separately from the filling conduit 51. It likewise projects into the cavern 6 by its opening 54 and leads out of the cavern 6 upward to the use units 3 with the fuel cell 31. The two conduits of the dual-directional conduit 5, the filling conduit 51 and the withdrawal conduit 52, are run into the cavern 6 spaced apart from one another, but adjacent to one another, in the first embodiment shown in FIG. 1. This achieves the effect that effects that occur at the opening 53 of the filling conduit 51, such as flow vortexes, do not affect the flow characteristics of the hydrogen gas flowing out of the cavern into the opening 54 of the withdrawal conduit 52. The separate design of the filling conduit 51 from the withdrawal conduit 52 enables independent filling and withdrawal. In this way, it is possible to continue to feed hydrogen gas into the cavern 6 via the filling conduit 51 irrespective of whether hydrogen gas is being withdrawn or not via the separate withdrawal conduit 52. The converse is also applicable; it is possible to withdraw hydrogen gas via the separate withdrawal conduit 52 and feed it to the use units 3 irrespective of whether hydrogen gas is being introduced simultaneously or not into the cavern 6 via the filling conduit 51.

Apart from the fuel cell 31, the use units 3 may also have further units for use of the hydrogen gas. For example, there may be further provision of a methanation plant 33 that synthesizes methane gas from the hydrogen gas supplied with addition of carbon dioxide, which may in particular be withdrawn from the air as CO2. The methane gas can be fed into a natural gas grid 93 (shown merely symbolically) in a manner known per se. Also provided as a further use unit may be feeding of hydrogen gas withdrawn from the cavern 6 via the withdrawal conduit 52, via a transfer point 35, into a gas grid that may be a natural gas grid or hydrogen gas grid (not shown). In this way, direct use of the stored hydrogen is also enabled.

In order to enable the operator of the system to select between the different modes of use, a gas manifold 30 is provided in the withdrawal conduit 52. It is connected upstream of the use units 3 and determines which of the use units 3 is supplied with the hydrogen gas withdrawn from the cavern 6 by means of the withdrawal conduit 52, namely the fuel cell 31, the methanation plant 33 or the transfer point 35 for direct supply. The gas manifold 30 is optionally capable of handling substreams, meaning that it divides the hydrogen gas stream coming from the withdrawal conduit 52 such that more than one of the use units 3 is supplied with hydrogen gas, for example the fuel cell 31 and the methanation plant 33 receive the hydrogen gas withdrawn.

Also provided is a controller 8 of the system, which is designed in particular to provide control power for the electricity grid 91. For this purpose, a target value input 80 is provided, to which an operator of the electricity grid 91 or another superior instance (not shown) can supply a signal for a required control power. The controller 8 is further connected to the fuel cell 31 via a first signal conduit 81 and to the gas generator 2 via a second signal conduit 82, and thus influences the operation thereof. If the network operator requires positive control power, for example, the controller 8 actuates the fuel cell 31 via the signal conduit 81 in such a way that it generates more electrical power and correspondingly withdraws more hydrogen gas from the cavern 6 via the withdrawal conduit 52. Because of the dual-directional conduit 5, this is possible at any time, completely regardless of whether or not the gas generator 2 is simultaneously feeding hydrogen gas into the cavern 6 via the filling conduit 51. It is thus possible to react very quickly to a demand for control power, within a few seconds. There is no need for a changeover of gas connections or a change in direction in a (possibly long) connection pipe to the cavern.

The same applies to the converse case, if negative control power is demanded via the target value input 80. For this purpose, the controller 8, via the signal conduit 82, actuates the gas generator 2, which draws more electrical power from the electricity grid 91 and generates more hydrogen gas by means of the electrolyzer, which is led into the cavern 6 via the filling conduit 51 and stored intermediately therein. This can be effected irrespective of whether hydrogen gas is being withdrawn or not via the withdrawal conduit 52 at that time. It is thus possible, in the case of existence of surplus power in the electricity grid 91, which is particularly important for practical purposes, to quickly and effectively remove the surplus power from the electricity grid 91 by means of the system and store it in the cavern 6 as hydrogen gas. This energy is then available again therein at any time, for example by conversion back to power by means of the fuel cell 31, or for use in some other way, for example by means of the methanation plant 33 (or by direct feeding via the transfer point 35 into a gas grid).

It is thus possible with the system 1 to draw surplus power from the electricity grid 91 to a considerable extent and in a highly dynamic manner and to store the corresponding energy in the cavern 6 in the form of hydrogen gas. The downregulation of wind turbines associated with known techniques as a measure for grid stabilization in such a case has thus been made superfluous. The waste of renewable energy available per se which is associated with the downregulation can thus be ended.

The system can provide control power on a large scale. Because of the highly dynamic response, this can be effected in seconds, such that even the provision of primary control power (second reserve) is enabled. Reference is now made to FIG. 2, which shows the types of control power that arise from the corresponding network operator guidelines and their relationship over time. Numeral I represents primary control power, which has to be provided in full, as what is called second reserve, within a period of 30 seconds. It is typically necessary to cover a period of up to 15 minutes. Primary control power is followed by secondary control power, which is represented by numeral II in FIG. 2 and may partly overlap with primary control power I. This has to be provided in full within a period of 5 minutes. This is ultimately followed by what is called minute control power, which is identified by numeral III in FIG. 2 and has to be provided in full by no later than 15 minutes. It is only long thereafter, in practical terms only after nearly one hour, that compensation via balancing circuits then ultimately kicks in, as identified by numeral IV in FIG. 2.

It will be apparent that provision of primary control power I requires a highly dynamic response, whereas a high capacity in relation to the energy to be provided (power over time) is required for the longer-term provision of, in particular, secondary control power and minute reserve power II and III. Both of these are achieved by the system 1 because of the gas generator 2 and CHP plant or the fuel cell 31, both of which are rapidly controllable, and the cavern 6 with its large storage volume. The system 1 is thus able to provide all kinds of control power I, II and III. An additional bonus is the further option of opening up other possible uses with the stored hydrogen gas, in order, for example, to produce other energy carriers such as methane or to use the hydrogen gas directly, whether in admixture in a (conventional) natural gas grid or even in a pure hydrogen gas grid.

In order to further increase the speed of dynamic response in the provision of control power, it is also possible to provide a buffer accumulator 15. This is respectively connected to the electrical side both of the gas generator 2 designed as electrolyzer and of the fuel cell 31. It is thus capable of quickly absorbing or releasing power or power spikes, and hence further ensures rapid response characteristics of the system.

FIG. 3 shows a second embodiment of the system. Components that are the same or of the same type and have the same or a similar function are given the same reference numeral, and reference is made to the above description for further elucidation thereof. The second embodiment differs from the first embodiment shown in FIG. 1 in that a bypass conduit 7 is disposed between the filling conduit 51 and withdrawal conduit 52. This bypass conduit 7 can be used to supply the hydrogen gas generated by the gas generator 2 directly to the use units 3 in order, for example, to feed the methanation plant 33 therein or to be fed directly into a hydrogen or natural gas grid via the transfer point 35. The bypass conduit 7 is provided with a switchable shutoff valve 71 that blocks or opens the bypass conduit 7. It is connected via a signal conduit (not shown) to the controller 8, which actuates the shutoff valve 71 depending on the status of the system 1 in the current situation and hence opens or closes the bypass conduit 7.

FIG. 4 shows a third embodiment of the system. Components that are the same or of the same type and have the same or a similar function are given the same reference numeral, and reference is made to the above description for further elucidation thereof. The third embodiment differs from the second embodiment in that the dual-directional conduit 5 with its filling conduit 51 and the separate withdrawal conduit 52 are disposed in a common pipe shaft 40 (and not each in a separate drill shaft as in the first and second embodiments). The fundamental benefits of the system 1 of being able simultaneously both to feed hydrogen gas into the cavern 6 and hence to provide negative control power to the electricity grid 91 and simultaneously to withdraw hydrogen by means of the separate withdrawal conduit 52 for the use units 3, for example in order to generate methane by means of the methanation plant 33, are fully retained in this embodiment. However, the disposing of the dual-directional conduit 5 in a common pipe shaft 40 distinctly simplifies the production of the pipe connection to the cavern 6 with the dual-directional conduit 5, which enables more economic production of the system.

1. A system for stabilization of an electricity grid, the system comprising:
a gas generator for a gaseous fuel, the gas generator being fed from the electricity grid; and
a connection pipe that leads into a cavern, wherein energy is stored by introducing the gaseous fuel generated by the gas generator into the cavern via the connection pipe, and wherein the gaseous fuel is withdrawn from the cavern for extraction of energy, wherein the connection pipe is configured as a dual-directional conduit leading into the cavern and comprises a filling conduit and a withdrawal conduit.

2. The system of claim 1, wherein the dual-directional conduit is configured for continuous feeding, independently of the withdrawing of gaseous fuel, and/or for continuous withdrawal, independently of the continuous feeding.

3. The system of claim 1, wherein multiple different use units for the gaseous fuel withdrawn from the cavern are connected to the withdrawal conduit.

4. The system of claim 3, wherein the multiple different use units are connected to the withdrawal conduit via at least one switchable gas manifold, wherein the gaseous fuel withdrawn flows to one of the multiple different use units according to a switching state of the at least one switchable gas manifold.

5. The system of claim 4, wherein the at least one switchable gas manifold is configured for switching of substreams of the withdrawn gaseous fuel.

6. The system of claim 4, wherein the at least one switchable gas manifold is switchable during continuous withdrawal of the gaseous fuel.

7. The system of claim 4, wherein one of the multiple different use units is an apparatus for reconversion of the withdrawn gaseous fuel to power, and wherein the apparatus is a fuel cell or combined heat and power plant that generates electrical power and releases the electrical power to an output conduit for connection to the electricity grid or a consumer.

8. The system of claim 4, wherein one of the multiple different use units is a methanation plant configured to synthesize methane by means of hydrogen.

9. The system of claim 4, wherein one of the multiple different use units is a transfer point to a natural gas grid wherein the gaseous fuel withdrawn is released to the natural gas grid.

10. The system of claim 1, comprising a controller for control power, wherein the controller has an inlet for a signal for negative control power and is configured to actuate the gas generator such that a power corresponding to the negative control power is drawn from the electricity grid for production of gaseous fuel, and wherein the gaseous fuel is introduced into the cavern.

11. The system of claim 10, wherein the controller for negative control power acts on a reconversion-to-power device to feed additional power as positive control power into the electricity grid.

12. The system of claim 1, wherein a switchable bypass conduit is connected to the filling conduit between the gas generator and the cavern, and wherein the switchable bypass conduit connects the gas generator and the cavern to the withdrawal conduit.

13. The system of claim 1, wherein a buffer accumulator is fed by the electricity grid connected to the gas generator and is designed for rapid supply, power release, and/or power uptake.

14. The system of claim 1, wherein the filling conduit and the withdrawal conduit are connected to the cavern with a spacing between the filling conduit and the withdrawal conduit.

15. The system of claim 1, wherein the filling conduit and the withdrawal conduit are adjacent.

16. The system of claim 1, wherein a distance between the filling conduit and the withdrawal conduit is between three times and thirty times; the diameter of the filing conduit and the withdrawal conduit.

17. The system of claim 1, wherein the filling conduit and the withdrawal conduit are connected to the cavern in a common drill shaft.

18. The system of claim 1, wherein the filling conduit and the withdrawal conduit reach into the cavern to different depths, and wherein the filling conduit reaches deeper into the cavern.

19. The system of claim 1, wherein the cavern is formed in a salt dome and/or is configured for an operating pressure of at least 40 bar.

20. The system of claim 19, wherein the cavern is configured for an operating pressure of up to 200 bar.

21. The system of claim 1, wherein the gaseous fuel is hydrogen.
